(19) United States
(12) Patent Application Publication
(10) Pub. No.: US 2005/0264098 A1
(43) Pub. Date: Dec. 1, 2005

(54) Sunburst axel cover

(76) Inventor: Douglas S. Huber, St. Charles, MO (US)

Correspondence Address: Douglas Scott Huber, 1509 Booneslick, St. Charles, MO, 63301, US

(21) Appl. No.: 10/772,256

(22) Filed: Jun. 1, 2004

(51) Int. Cl. B60B 35/00

(52) U.S. Cl. 301/124.1

(57) ABSTRACT

This is a new invention. The wheel cover casting is bolted to the outside of the axle to give a very pleasant look to the axle and to the overall appearance of the truck.

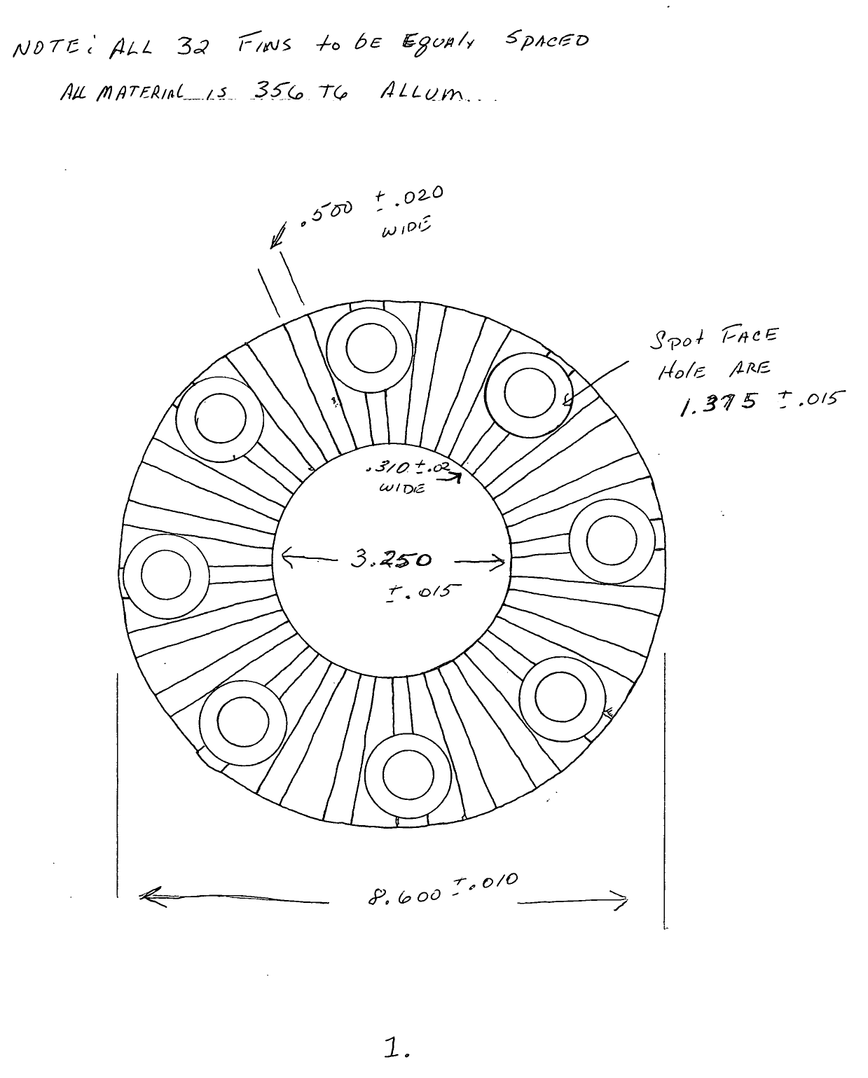

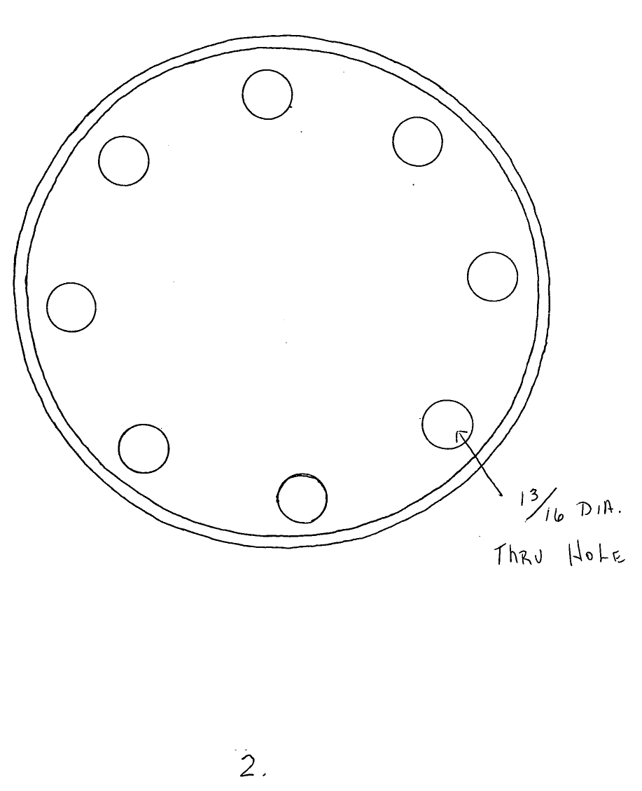

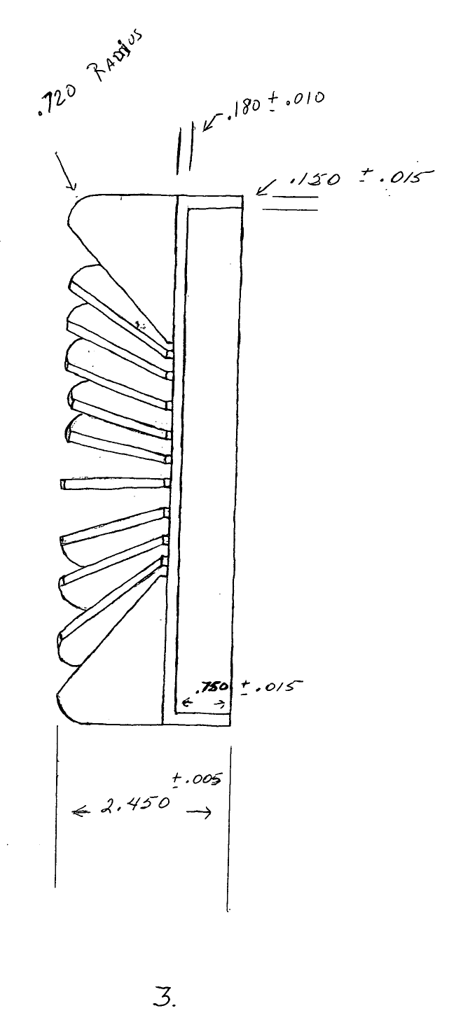

This is an aluminum casting that is machined by holding on the outer diameter first, and machining the back of the casting so that the chuck-jaw will hold onto the back inside of the casting. The front of the casting can be machined to size. Next, the casting is placed in a fixture and holes are drilled to tolerance.

After the machining, drilling, and deburring are done, the casting can then be placed on the studs of an axle of a semi-truck. The nuts can be secured with a wrench.

### DESCRIPTION OF DRAWING VIEWS

Drawing #1 is the front view of the casting after complete machining.

Drawing #2 is the side view if casting was cut in half.

Drawing #3 is the back view of casting after finish machining.

1. I, Douglas s Huber, claim that I invented and made the design by myself. I am the first to invent this axle cover made from the pattern that I designed and made.
